(19) United States
(12) Patent Application Publication
(10) Pub. No.: US 2013/0231137 A1
(43) Pub. Date: Sep. 5, 2013

(54) LOCATION AGENT GEOFENCE

(71) Applicants: Rick Hugie, Calgary (CA); Josiah Lau, Calgary (CA); Seema Phalke, Calgary (CA); Ed Ferguson, Seattle, WA (US)

(72) Inventors: Rick Hugie, Calgary (CA); Josiah Lau, Calgary (CA); Seema Phalke, Calgary (CA); Ed Ferguson, Seattle, WA (US)

(21) Appl. No.: 13/783,725

(22) Filed: Mar. 4, 2013

Related U.S. Application Data
(60) Provisional application No. 61/605,920, filed on Mar. 2, 2012.

(51) Int. Cl. H04W 24/00

(52) U.S. Cl. CPC H04W 24/00
USPC 455/456.3

(57) ABSTRACT

A least squares geofence method that introduces inventive geofence steps and modifies existing geofence steps to minimize trigger misfires caused by data variability and location blunders and to minimize delayed/missed entry triggers generated under urban and/or indoor conditions. The least squares geofence method periodically retrieves sample locations for a target wireless device to determine that device's geographic location and to evaluate a corresponding side condition. Sample locations retrieved with accuracies greater than 1 km are filtered. If a potential change in side condition is detected for a given device, the least squares geofence method retrieves five fast location fixes for that device and evaluates a weighted least squares (LS) location estimate based on sample locations retrieved. A LS location estimate is then filtered according to an anticipated trigger event and the least squares geofence method evaluates a final geofence side condition based on the LS location estimate previously computed.

The present invention claims priority from U.S. Provisional Application No. 61/605,920 to Hugie et al., entitled “Location Agent Geofence” filed Mar. 2, 2012, the entirety of which is expressly incorporated by reference.

### BACKGROUND OF THE INVENTION

1. Field of the Invention

This invention relates generally to communications. More particularly, it relates to location-based services.

2. Background of Related Art

Location enabling technology is implemented in a vast majority of today's handheld mobile devices as a result of a Federal Communications Commission (FCC) mandate requiring wireless devices to incorporate location technology, in the event wireless users need to be located throughout use of emergency services, e.g., E911. Location enabling technologies generally implemented in mobile devices include a precise satellite-enabled Global Positioning System (GPS), cell tower positioning, network access points, and several other tracking technologies capable of delivering approximate location of a wireless device. This vast incorporation of location enabling technology in today's handheld mobile devices has consequently led to a growing emergence of location based services (LBS). A location based service (LBS) obtains a geographic location of a wireless device and provides services accordingly.

For instance, a geofence method is an existing location based service (LBS) that monitors location information for a wireless device, and enables an administrator to trigger a predetermined event (e.g. a user-defined event) each instance that monitored device enters/exits a specified geographic boundary (i.e. proximity range).

To implement a geofence method, an administrator defines a geofence (i.e. a virtual spatial boundary) around a geographic location of interest (e.g., a point on a map, a school campus, a state, etc.), and articulates one or more target devices to monitor against that predefined geofence. A geofence administrator additionally defines one or more entry/exit events for each desired target device/geofence combination.

In operation, whenever a geofence method detects a target device entering/exiting a predefined geofence, the geofence method automatically generates an entry/exit trigger, to trigger delivery of a predetermined entry/exit event defined for that particular target device/geofence combination. An entry/exit event may be, e.g., an advertisement, digital coupon, reminder, etc., triggered to a target device entering/exiting a relevant geofence. Moreover, an entry/exit event may additionally/alternatively be, e.g., an alert, reminder, notification, etc., triggered to a relevant geofence administrator.

A conventional geofence method monitors location data for a target device to determine that device's geographic location and trigger entry/exit events accordingly.

A user may desire to implement a conventional geofence method for any of a multitude of reasons. For instance, a geofence method may be implemented to trigger digital coupons to a target device when that device is within close proximity to a predefined geofence, i.e., a store, restaurant, city, etc. Moreover, a geofence method may enable family members to monitor location information for other family members and/or employers to track employee whereabouts. In addition, a geofence method may trigger offers/discounts to participating consumers for businesses/stores within those consumers' general vicinity. Furthermore, a geofence method may enable law enforcement to better monitor tracking devices and/or a homeowner to remotely activate/deactivate home appliances when a relevant device enters/exits a relevant geofence.

Although a geofence method does encompass numerous advantageous uses, current geofence methods unfortunately experience occasional trigger misfires as a result of data variability and/or location blunders. In addition, current geofence methods occasionally generate delayed/missed entry triggers when performed under urban and/or indoor conditions. As a result, the present inventors have appreciated that there is a need for an improved geofence method that generates entry/exit geofence triggers more accurately without adversely affecting battery consumption.

### SUMMARY OF THE INVENTION

In accordance with the principles of the present invention, a geofence method and technology that increases the probability of accurate entry/exit geofence triggers without additionally increasing the probability of inaccurate entry/exit geofence triggers, comprises a least squares geofence method. A least squares geofence method introduces inventive geofence steps and modifies existing geofence steps to minimize trigger misfires caused by data variability and location blunders, and to minimize delayed/missed entry triggers generated under urban and/or indoor conditions. Inventive steps introduced in the least squares geofence method include: get trigger side fast, filter locations, calculate least squares location, and entering or exiting filter. Existing geofence steps modified in the inventive least squares geofence method include: wait until next fix time, enter slow fix mode, and get location.

In accordance with the principles of the present invention, inventive step get trigger side fast alerts the least squares geofence method to a potential change in geofence side condition (i.e. trigger side) for a specified target device. More particularly, get trigger side fast uses a point in circle algorithm to determine whether a location retrieved for a target device is inside or outside a predefined geofence.

Moreover, inventive step filter locations filters sample location points retrieved for a target wireless device to minimize the effect of coarse locates on location estimates computed via the least squares geofence method.

In accordance with the principles of the present invention, inventive step calculate least squares location calculates a weighted least squares location estimate for a target wireless device using sample location points retrieved for that device via a conventional fast fix cycle. Calculate least squares location uses a weighted least squares (LS) model to compute a least squares (LS) fit (i.e. a least squares location estimate) of sample location points retrieved for a target wireless device. A least squares (LS) fit calculation computed via step calculate least squares location is used to determine if a relevant device is located inside or outside a predefined geofence.

In accordance with the principles of the present invention, inventive step entering or exiting filter filters least squares location estimates computed for a target wireless device. A loose exiting filter (500 m) is used to filter a least squares location estimate computed for a device potentially exiting a geofence and a tighter entering filter (100 m) is used to filter a least squares location estimate computed for a device potentially entering a geofence.

In accordance with another aspect of the present invention, existing geofence step wait until next fix time is modified from its original form in the least squares geofence method to only take location position in to account and not location accuracy.

Moreover, existing step enter slow fix time is modified within the inventive least squares geofence method to switch back to a slow fix mode from a fast fix mode after attempting to get 4 additional fast fixes (regardless as to whether fast fixes are successful or not) for a specified target device. The inventive enter slow fix mode does not require the least squares geofence method to evaluate a geofence side condition after each individual location fix retrieved for a target device. Rather, the least squares geofence method only evaluates one geofence side condition for a target device, based on a least squares location estimate computed using 5 sample location points retrieved for that particular target device.

In accordance with the principles of the present invention, existing step get location is modified in the least squares geofence method to use a 15 second GPS timeout in a fast fix cycle rather than a conventional 45 second GPS timeout. Modifications to existing step get location permit the least squares geofence method to avoid excessive delay (a maximum delay of 7.5 minutes) when attempting to retrieve 5 sample location points for a target device located in an indoor environment.

### BRIEF DESCRIPTION OF THE DRAWINGS

Features and advantages of the present invention become apparent to those skilled in the art from the following description with reference to the drawings:

FIG. 1 depicts an exemplary least squares geofence method call flow, in accordance with the principles of the present invention.

FIG. 2 depicts coarse locates retrieved for a given target device, in accordance with the principles of the present invention.

FIG. 3 depicts a weighted least squares (LS) location estimate computed for a target wireless device, in accordance with the principles of the present invention.

FIG. 4 depicts network locates used to compute a location estimate for a target wireless device, in accordance with the principles of the present invention.

FIG. 5 depicts exemplary GPS locates retrieved for a device in motion, in accordance with the principles of the present invention.

FIG. 6 depicts error circles for a series of indoor locates retrieved for a target wireless device, in accordance with the principles of the present invention.

FIG. 7 depicts exemplary trigger misfires generated when only 3 sample location points are used to calculate location estimates for a target wireless device, in accordance with the principles of the present invention.

FIG. 8 depicts exemplary geofence triggers generated when a location estimate is computed using 5 sample location points retrieved for a target wireless device, in accordance with the principles of the present invention.

FIG. 9 depicts indoor locates retrieved for a target device entering a predefined geofence, in accordance with the principles of the present invention.

FIG. 10 depicts indoor locates retrieved for a target device exiting a geofence, in accordance with the principles of the present invention.

FIG. 11 depicts indoor locates retrieved for a target wireless device via the existing geofence method.

FIG. 12 depicts location information for a device straddling a geofence boundary for a prolonged period of time, in accordance with the principles of the present invention.

FIG. 13 portrays an exit trigger generated for a device straddling a geofence boundary for a prolonged period of time, in accordance with the principles of the present invention.

FIGS. 14A through 14C depict exemplary geofence events triggered by both the least squares geofence method and the existing geofence method based on outdoor locates retrieved for a target wireless device, in accordance with the principles of the present invention.

FIG. 15 shows location information for a wireless device that is resident within three defined geofences, in accordance with the principles of the present invention.

FIG. 16 portrays a location log for an exemplary device that is stationary inside a geofence, in accordance with the principles of the present invention.

FIG. 17 portrays a location log for an exemplary wireless device that exits a new geofence and remains near the boundary of that geofence, in accordance with the principles of the present invention.

FIG. 18 shows a map of locations relative to the location log depicted in FIG. 17, in accordance with the principles of the present invention.

FIG. 19 depicts an exemplary geofence method call flow.

FIG. 20 depicts three exemplary fast location fixes retrieved for a target device located inside a predefined geofence.

FIG. 21 depicts three exemplary fast location fixes retrieved for a target device located outside a predefined geofence.

### DETAILED DESCRIPTION OF ILLUSTRATIVE EMBODIMENTS

The present invention comprises a least squares geofence method and technology that utilizes as much data as possible to increase the probability of accurate entry/exit geofence triggers without additionally increasing the probability of inaccurate entry/exit geofence triggers. In particular, an inventive least squares geofence method alters an existing geofence method to address two major issues: delayed/missed entry triggers under urban and/or indoor conditions; and trigger misfires caused by data variability and location blunders.

In accordance with the principles of the present invention, the least squares geofence method comprises the following events: determining when and how to gather sample location points for a target wireless device; computing a location estimate for said target wireless device based on gathered sample location points; filtering said computed location estimate based on a current state (i.e. geofence side condition) of said target wireless device; and evaluating whether an event has been triggered.

In accordance with the principles of the present invention, the least squares geofence method analyzes location data retrieved for a target wireless device, to evaluate a geofence side condition for that particular device. If the value of a geofence side condition is ‘inside’ for a target wireless device, that device is currently located inside a predefined geofence. Likewise, if the value of a geofence side condition is ‘outside’ for a particular target device, that device is currently located outside a predefined geofence. An entry/exit geofence trigger is generated whenever a change in geofence side condition is detected for a target wireless device.

The present inventors have appreciated that controlling how often to obtain sample location points for a target wireless device, and determining an appropriate amount and type (e.g. GPS, network, cell, etc.) of sample location points to obtain, is key to generating accurate entry/exit geofence triggers.

The least squares geofence method disclosed herein assumes that useful information may be obtained from all data retrieved for a target wireless device. Moreover, the present invention assumes that the key to obtaining such useful information lies particularly in the manner in which data is extracted. For instance, a correlation of sample location points retrieved for a target wireless device may signify the accuracy of a resultant location estimate. For example, a location estimate that is computed based on a single sample location point may not yield much statistical confidence. Yet, a location estimate based on a series of sample location points, all retrieved within a span of 10 meters, may yield significantly high statistical confidence.

To trigger a geofence reliably, location information for a target device must be determined with a high level of confidence. In accordance with the principles of the present invention, the least squares geofence method obtains enough sample location points to capture the true variability of a geographic position of a wireless device, without adversely affecting battery consumption.

The least squares geofence method disclosed herein implements statistical techniques to estimate a geographic location of a wireless device based on several sample location points. More particularly, the least squares geofence method uses a conventional weighted least squares (LS) model to compute a weighted best estimate of a geographic position of a wireless device. A conventional weighted least squares (LS) model is simplified within the context of the present invention to reduce computational intensity.

In addition, the present inventors have appreciated that filtering data at an appropriate time is yet another key to increasing accurate entry/exit geofence triggers without additionally increasing inaccurate entry/exit geofence triggers. Sample location points retrieved for a target device are filtered prior to computing a location estimate for that particular target device. Moreover, least squares (LS) location estimates are subsequently computed and filtered, in accordance with an anticipated trigger event.

The least squares geofence method must be careful to avoid false positives (i.e. false entry/exit triggers) caused by location blunders retrieved for a target wireless device. A blunder is a data point that does not contain any truth. Hence, a blunder is detrimental to a location estimate and therefore filtered by the least squares geofence method before a location estimate is computed.

To avoid computing a location estimate that contains/reflects location blunders, the present invention filters (i.e. rejects) locations with poor accuracies retrieved for a target wireless device. However, the least squares geofence method is also careful not to filter all locations retrieved for a target wireless device. For instance, a device exiting a geofence is often travelling, sometimes at high speeds. Being that sample data retrieved for a device in motion is not well correlated, the present invention cannot filter all locations with meager accuracies retrieved for a target wireless device. In accordance with the principles of the present invention, when a state of a target device is ‘inside’, the least squares geofence method filters all positions computed for that device with poor accuracies, and instead only evaluates positions computed for that device with medium accuracies.

The least squares geofence method only generates an entry trigger when a target device enters and remains inside a geofence. Consequently, the least squares geofence method assumes that movement of a target device inside a geofence is limited. In accordance with the principles of the present invention, when a state of a target device is ‘outside’, the least squares geofence method filters all positions computed for that device with poor and medium accuracies, and instead only evaluates positions computed for that device with high accuracies. Hence, the least squares geofence method applies a stricter filter to detect a geofence entry than it does to detect a geofence departure.

The least squares geofence method modifies a conventional geofence filtering technique, so that events may be triggered using indoor locates without provoking severe boundary issues. Moreover, to reduce geofence complexity and potential future issues, the present invention prefers to use general rules to filter a computed location estimate, as opposed to specific rules tailored to each use case.

In accordance with the principles of the present invention, the least squares geofence method comprises two particular cases of interest: exiting a geofence and entering a geofence. When a target device is inside the geographical confines of a geofence (i.e. the device's current state of nature is ‘inside’), the only alternative available to that device is to exit. Likewise, when a target device is outside the geographical confines of a geofence (i.e. the device's current state of nature is “outside”), the only alternative available to that device is to enter. Further, in terms of entering, the present invention is only interested in the scenario in which a device enters and remains inside a geofence. Similarly, in terms of exiting, the present invention is only interested in the scenario in which a device exits and remains outside a geofence (i.e. when a device has truly exited a geofence). The least squares geofence method thoroughly analyzes location data retrieved for a target wireless device to evaluate whether an entry/exit event has been triggered.

In particular, the least squares geofence method uses techniques of the existing gaussian geofence to evaluate whether an entry/exit event has been triggered. However, instead of computing 3 separate geofence side conditions for a target wireless device, based on 3 separate sample location points (as performed in a conventional geofence method), the least squares geofence method computes only one geofence side condition for that target device, using a least squares (LS) location estimate based on several sample location points.

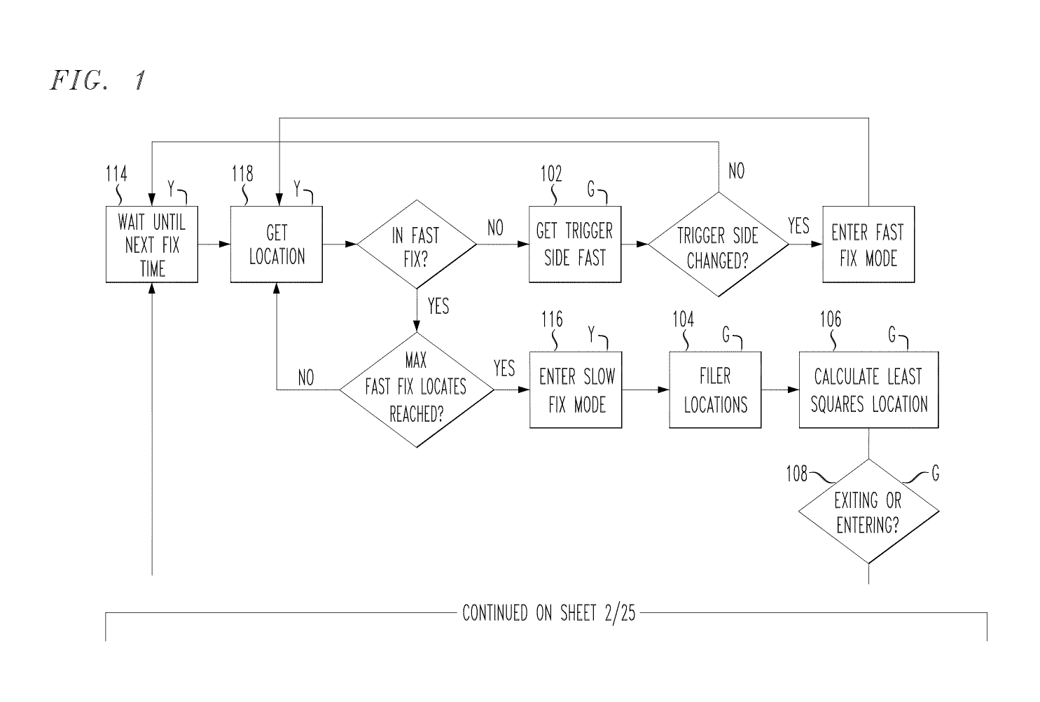

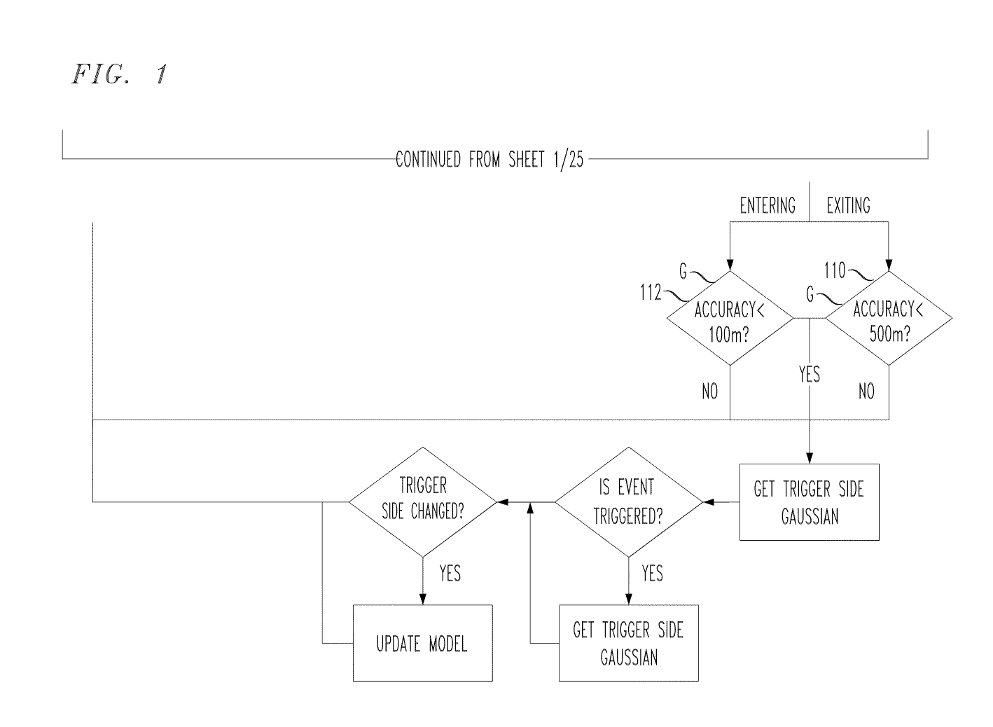

FIG. 1 depicts an exemplary least squares geofence method call flow, in accordance with the principles of the present invention.

As depicted in FIG. 1, new steps introduced in the least squares geofence method are designated ‘G’, and modifications made to existing steps in the existing geofence method are designated ‘Y’. New steps G shown in FIG. 1 modify the manner in which location data is captured, filtered, and used in the existing geofence method.

In particular, get trigger side fast 102 is an inventive geofence step that uses a point in circle algorithm to evaluate whether a location retrieved for a target wireless device is inside a predefined geofence. In accordance with the principles of the present invention, get trigger side fast 102 returns an “outside”, “boundary”, or “inside” condition, according to an outcome produced by the point in circle algorithm. Get trigger side fast 102 does not take location accuracy in to account.

In accordance with the principles of the present invention, get trigger side fast 102 alerts the least squares geofence method to a potential change in geofence side condition for a specified target device, so that such a change may be investigated further through a fast fix cycle.

Table 1 shows criteria required to meet an “inside”, “outside”, and “boundary” condition returned by get trigger side fast 102.

TABLE 1

| Condition | Criteria |
|---|---|
| Inside | Distance/Radius < 80% |
| Outside | Distance/Radius > 120% |
| Boundary | Otherwise |

In particular, if a distance between a current location of a target wireless device and the center point (i.e. latitude and longitude of the center of a geofence) of a relevant geofence, divided by the radius of that relevant geofence is less than 80%, get trigger side fast returns an “inside” condition for that target wireless device. Moreover, if a distance between a current location of a target device and the center point (i.e. latitude and longitude of the center of a geofence) of a relevant geofence, divided by the radius of that relevant geofence is greater than 120%, get trigger side fast returns an “outside” condition for that target wireless device. Otherwise, get trigger side fast returns a “boundary” condition for that target wireless device.

Filter locations 104 is an inventive step that is introduced in the least squares geofence method to filter sample location points retrieved for a target wireless device. Filter locations 104 is implemented in the least squares geofence method before a location estimate is computed for a target wireless device.

A conventional least squares (LS) model relies on the assumption that all data points (no matter how inaccurate) contain some truth. However, the present inventors have recognized (through researching certain Long Term Evolution (LTE) devices) that coarse locates are data points that do not contain any truth, and are therefore better considered blunders as opposed to valid data. In accordance with the principles of the present invention, filter locations 104 minimizes the effect of blunders and coarse locates on location estimates computed in the least squares geofence method.

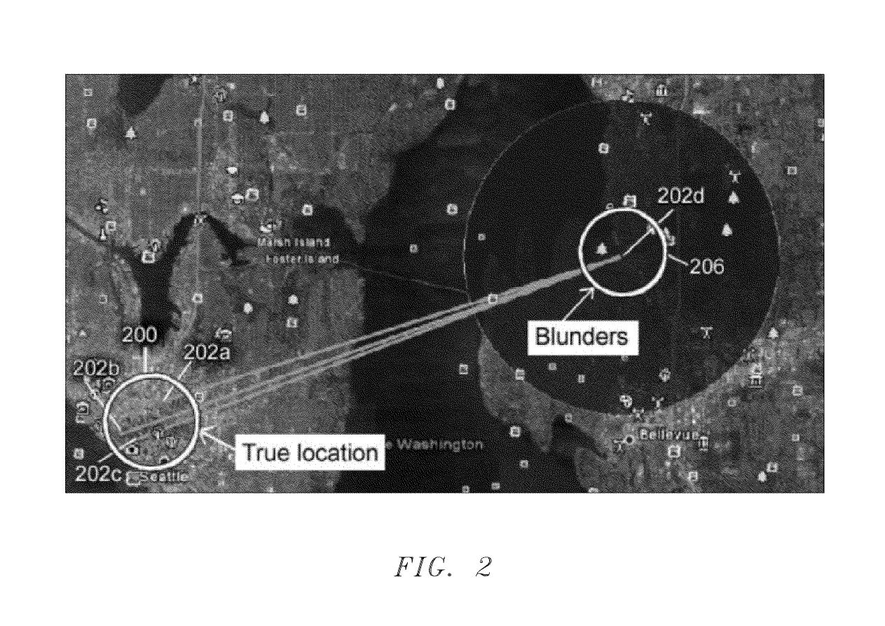

FIG. 2 depicts coarse locates retrieved for a target wireless device, in accordance with the principles of the present invention.

In particular, FIG. 2 depicts a set of sample location points 202 retrieved for a wireless device that is stationary at a Seattle office 200. However, as depicted in FIG. 2, sample location points 202 retrieved for the stationary wireless device periodically jump across Lake Washington 204. Although the accuracy of coarse locates 206 retrieved for the stationary wireless device is approximately 1.5 km, the true error of coarse locates 206 is actually over 11 km. Hence, course locates 206 depicted in FIG. 2 are better considered blunders as opposed to valid data.

Filter locations 104 minimizes the effect of coarse locates on location estimates computed via the least squares geofence method. In particular, before a location estimate is computed for a target wireless device, filter locations 104 filters sample location points (i.e. location inputs) retrieved for that device with accuracies greater than 1 km. Hence, locations having accuracies greater than 1 km are not used to compute location estimates in the inventive least squares geofence method.

Calculate least squares location 106 is yet another inventive step introduced in the least squares geofence method. Calculate least squares location 106 calculates a location estimate for a target wireless device using a conventional weighted least squares (LS) model. A conventional weighted least squares (LS) model naturally places more emphasis on good quality data and less emphasis on poor quality data retrieved for a target wireless device.

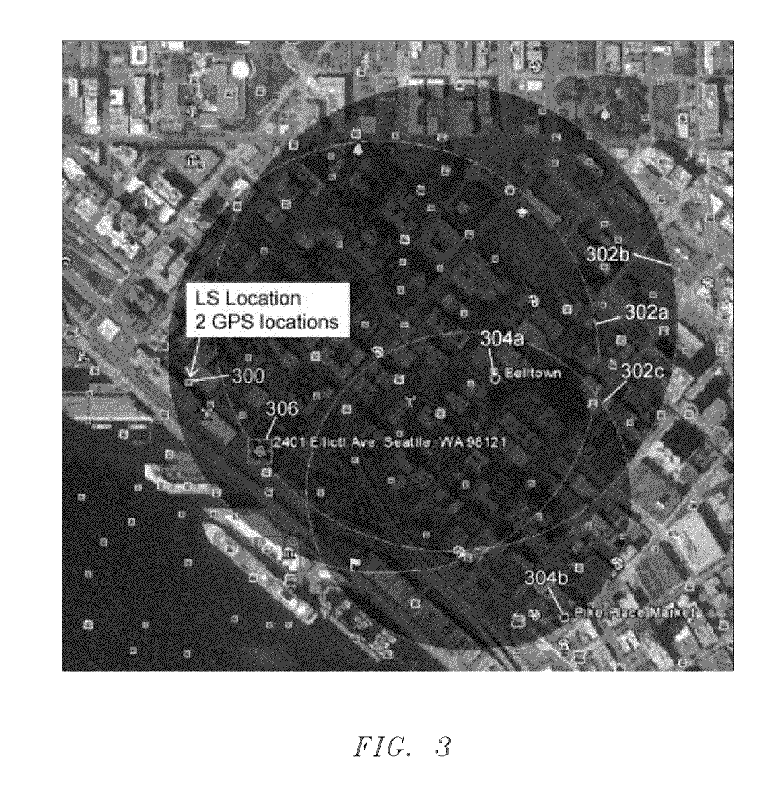

FIG. 3 depicts an exemplary weighted least squares (LS) location estimate computed for a target wireless device, in accordance with the principles of the present invention.

In particular, FIG. 3 depicts a weighted least squares (LS) location estimate 300 computed using 3 network locates 302 and 2 GPS locates 304 retrieved for a target wireless device 306. As depicted in FIG. 3, when computing the weighted least squares (LS) location estimate 300, the weighted least squares model naturally gravitates toward the 2 GPS locates 304 retrieved for the target device and naturally de-weights the 3 network locates 302.

In accordance with the principles of the present invention, filter locations 104 is the only filter that is required at the data input level of the least squares geofence method, due to use of a weighted least squares (LS) model to compute location estimates.

In accordance with the principles of the present invention, calculate least squares location 106 calculates a weighted least squares (LS) location estimate for a target wireless device based on sample location points retrieved for that device in a conventional fast fix cycle. At least 2 valid sample location points are required to compute a least squares (LS) location estimate for a target wireless device. The weighted least squares (LS) model used within the inventive least squares geofence method assumes that all sample location points retrieved for a target wireless device, describe a true location.

The parametric least squares (LS) model employed in the least squares geofence method is described by the following equations:

$$F ( {x}_{i} ) = {x}_{0} , \\ F ( {y}_{i} ) = {y}_{0} ;$$

$$\hat{x} = {X}_{0} + \hat{δ}$$

$$Where , \\ {X}_{0} = [ \begin{matrix}{x}_{o} \\ {y}_{o}\end{matrix} ] = [ \begin{matrix}0 \\ 0\end{matrix} ]$$

$$( set initial estimates equal to zero )$$

$$\hat{δ} = - {( N )}^{- 1} u$$

$$N = {A}^{T} PA$$

$$u = {A}^{T} Pw$$

$$A = [ \begin{matrix}\frac{\partial F ( {x}_{i} )}{\partial x} & \frac{\partial F ( {x}_{i} )}{\partial y} \\ \frac{\partial F ( {y}_{i} )}{\partial x} & \frac{\partial F ( {y}_{i} )}{\partial y} \\ ⋮ & ⋮\end{matrix} ] = [ \begin{matrix}1 & 0 \\ 0 & 1 \\ ⋮ & ⋮\end{matrix} ]$$

$$P = {C}_{l}^{- 1} = [ \begin{matrix}{σ}_{x 1}^{2} & {σ}_{{x}_{1} {y}_{1}} & 0 \\ {σ}_{{x}_{1} {y}_{1}} & {σ}_{y 1}^{2} & 0 \\ 0 & 0 & ⋱\end{matrix} ]$$

$$w = {X}_{0} - [ \begin{matrix}{x}_{1} \\ {y}_{1} \\ ⋮\end{matrix} ] = - [ \begin{matrix}{x}_{1} \\ {y}_{1} \\ ⋮\end{matrix} ]$$

$${c}_{i} = {\hat{σ}}_{0}^{2} {N}^{- 1}$$

$$Where , \\ {\hat{σ}}_{0}^{2} = \frac{{\hat{υ}}^{T} p \hat{υ}}{n - u}$$

$$\hat{υ} = A \hat{δ} + w$$

$$n = number of observations$$

$$u = number of unknowns$$

However, the present invention simplifies the previous process by eliminating the covariance between xₙ and yₙ and setting the variance of xₙ and yₙ equal. Simplification of the least squares (LS) fit calculation results in the following equations:

$$N = [ \begin{matrix}{N}_{x} & 0 \\ 0 & {N}_{y}\end{matrix} ]$$

$$Where , \\ {N}_{x} = {N}_{y} = \frac{1}{{σ}_{1}^{2}} + \frac{1}{{σ}_{2}^{2}} + … + \frac{1}{{σ}_{n}^{2}} ( Compute )$$

$$u = - [ \begin{matrix}{u}_{x} \\ {u}_{y}\end{matrix} ]$$

$$Where , \\ {u}_{x} = \frac{{x}_{1}}{{σ}_{1}^{2}} + \frac{{x}_{2}}{{σ}_{2}^{2}} + … + \frac{{x}_{n}}{{σ}_{n}^{2}} ( Compute )$$

$${u}_{y} = \frac{{y}_{1}}{{σ}_{1}^{2}} + \frac{{y}_{2}}{{σ}_{2}^{2}} + … + \frac{{y}_{n}}{{σ}_{n}^{2}} ( Compute )$$

$${\hat{σ}}_{0}^{2} = \frac{{( {x}_{1} - \hat{x} )}^{2} + {( {y}_{1} - \hat{y} )}^{2}}{{σ}_{1}^{2}} + \frac{{( {x}_{2} - \hat{x} )}^{2} + {( {y}_{2} - \hat{y} )}^{2}}{{σ}_{2}^{2}} + … + \frac{{( {x}_{n} - \hat{x} )}^{2} + {( {y}_{n} - \hat{y} )}^{2}}{{σ}_{n}^{2}} / ( n - u )$$

(Compute)

Solving for the unknowns results in the following:

\hat{x}=N_{X}⁻¹uₓ

ŷ=N_{y}⁻¹u_{y}

C_{\hat{x}}=C_{ŷ}\hat{σ}₀²Nₓ⁻¹

The previous solution simplifies a least squares (LS) fit calculation so that matrix inversions, multiplications, and additions are not required.

Table 2 shows operations required to perform steps in a least squares (LS) fit calculation implemented by the least squares geofence method, in accordance with the principles of the present invention.

TABLE 2

| Step | Operations |
|---|---|
| $Compute \frac{1}{{σ}_{n}^{2}}$ | N multiplications, N divisions |
| Compute Nₓ | N additions |
| Compute uₓ | N multiplications, N additions |
| Compute u_{y} | N multiplications, N additions |
| Compute \hat{σ}_{β}² | 2N subtractions, 2N additions, 3N multiplications, |
| | 1 division |

As depicted in Table 2, steps performed in a simplified least squares (LS) fit calculation do not contain operations involving costly square roots or trigonometric functions.

An inventive entering or exiting filter 108 is yet another step introduced in the least squares geofence method. An entering or exiting filter 108 is implemented in the least squares geofence method following computation of a least squares (LS) location estimate for a specified target device. Once step calculate least squares location has computed a least squares (LS) location estimate for a given target device, that location estimate is subsequently filtered by the entering or exiting filter 108 in accordance with an anticipated trigger event (i.e. whether a device is potentially entering or exiting a geofence). For instance, if method get trigger side fast 104 previously returned a state of ‘inside’ for a target device, but is now returning a state of ‘outside’, that target device may potentially be exiting a geofence. When a target device is potentially exiting a geofence, the least squares geofence method uses a loose exiting filter (500 m) 110 to filter a least squares (LS) location estimate computed for that device. Alternatively, when the current state of a target device is not ‘inside’, that target device may potentially enter a geofence at any given time. When a device is potentially entering a geofence, the least squares geofence method uses a tighter entering filter (100 m) 112 to filter a least squares (LS) location estimate computed for that particular device (to minimize the probability of false entry triggers).

Accuracy of a least squares (LS) location estimate is based on weighted residuals of a least squares (LS) model used to compute that location estimate. The least squares (LS) model used within the present invention assumes that all input locations retrieved for a given target device, describe the same location. Moreover, a small variance computed via the least squares (LS) model indicates that input locations are tightly correlated and the model is a good fit.

In accordance with the principles of the present invention, the least squares geofence method assumes that a device located inside a geofence is relatively stationary and points retrieved for that device via a fast fix cycle are tightly correlated. Consequently, sample location points having poor individual quality (>300 m) are able to yield a computed location estimate that is good quality (<100 m). This assumption permits the least squares geofence method to use even cell locates with large errors in a geofence calculation, because sample location points that are well-correlated yield a location estimate computed with high confidence. Input accuracies are not important to the least squares (LS) model employed by the least squares geofence method. Rather, input accuracies are only used to weigh inputs to a least squares (LS) model. Moreover, the fit of location data computed via a least squares (LS) model is used to develop an accuracy proclamation for a corresponding location estimate, in accordance with the principles of the present invention.

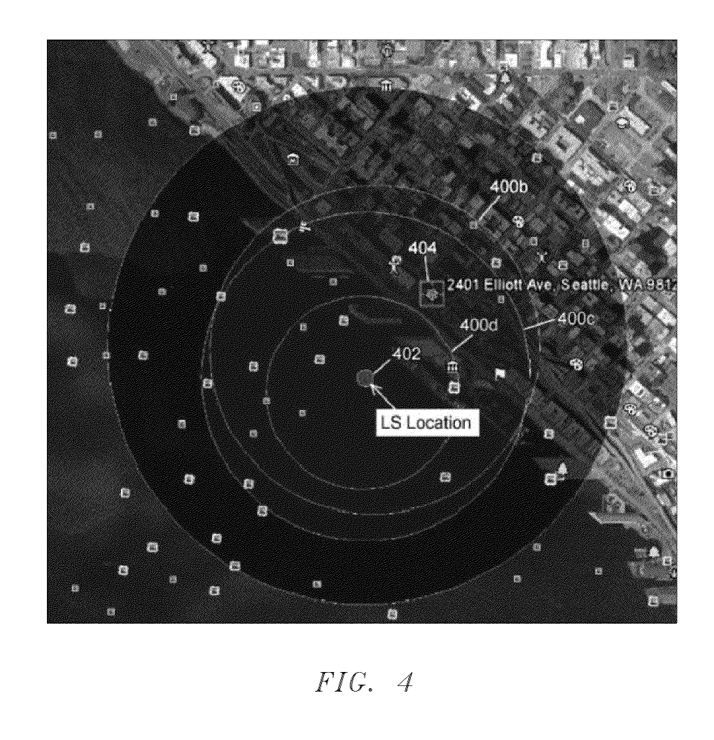

FIG. 4 depicts network locates used to compute a location estimate for a target wireless device, in accordance with the principles of the present invention.

In particular, 4 network locates 400 with accuracies between 250 m and 700 m are used to compute a least squares (LS) location estimate 402 for a target wireless device 404, as depicted in FIG. 4. Since network locates 400 shown in FIG. 4 are tightly correlated, the resultant location estimate 402 has an accuracy of less than 25 m.

A large variance indicates to the least squares geofence method that sample location points retrieved for a target wireless device are likely not describing the same location. Yet, although some sample location points are likely blunders when points retrieved for a target device yield an extremely poor fit, the least squares geofence method may not immediately conclude that such points are blunders because a device in motion is also likely to produce a model with poor fit.

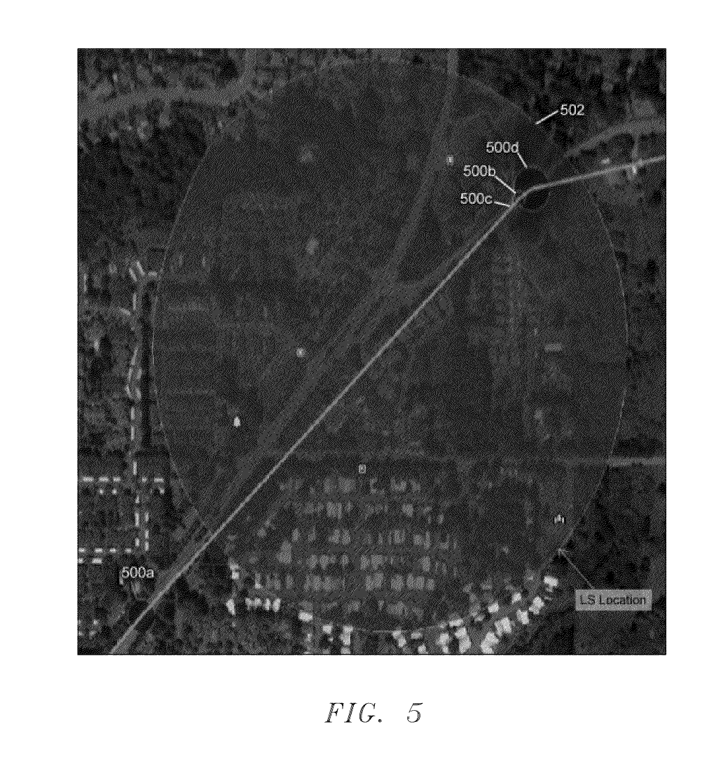

FIG. 5 depicts exemplary GPS locates retrieved for a device in motion, in accordance with the principles of the present invention.

For instance, FIG. 5 shows a least squares (LS) location estimate 502 computed based on 5 GPS locates 500 (4 of which are depicted in FIG. 5) retrieved for a device in motion. GPS locates 500 used to compute the least squares (LS) location estimate 502 depicted in FIG. 5 have individual accuracies of less than 60 m. However, the least squares (LS) location estimate 502 depicted in FIG. 5 yields an accuracy of approximately 350 m. To account for devices in motion, the least squares geofence method uses a loose filter to filter out blunders, while still allowing reasonable motion within the system.

Factors such as GPS drift, multipath, biases, atmospheric effects, and cell tower hopping can cause location accuracies to be poorer than actual. For instance, multipath in an urban environment can introduce a systematic error in GPS positions that is not accounted for in reported accuracies. Although a least squares (LS) geofence solution can produce an extremely accurate location estimate, the present invention accounts for unknown factors by limiting a least squares (LS) fit accuracy to 100 m. Limiting the least squares (LS) fit accuracy reduces boundary effects under unknown circumstances.

In addition to introducing new steps to the existing geofence method, the present invention additionally modifies existing geofence steps, to simplify the conventional geofence process and reduce any potential errors. Modifications made to existing geofence steps are labeled ‘Y’ in FIG. 1.

In particular, existing geofence step wait until next fix time 114 is slightly modified from its original form, in accordance with the principles of the present invention. Step wait until next fix time 114 calculates a next fix time for a target device and is simplified within the present invention to only take location position into account and not location accuracy.

Table 3 depicts a calculated next fix time for individual fix modes and related conditions, in accordance with the principles of the present invention.

TABLE 3

| Condition | Next Fix Time |
|---|---|
| Fast Fix Mode | 1 second |
| Slow Fix Mode: Distance <= 3 Miles | 3 minutes |
| Slow Fix Mode: Distance > 3 Miles | Distance/60 mph |

In particular, Table 3 depicts time allotted between individual location retrievals for different fix modes implemented in the least squares geofence method. A point in circle trigger side check is only performed in slow fix mode in the least squares geofence method, so accuracy at this level is not that important and added complexity is not required.

Enter slow fix mode 116 is another conventional geofence step modified within the present invention. An existing enter slow fix mode 116 switches back to a slow fix mode (from a fast fix mode) after 3 consecutive same side conditions or 3 boundary conditions (whichever comes first). Theoretically, the existing enter slow fix mode 116 may result in a maximum of 4 additional fast fixes for a given target device. However, inventive modifications to enter slow fix mode 116 permit the least squares geofence method to get 4 additional fast fixes, without evaluating a geofence side condition (i.e. trigger side) after each fix. Rather, the inventive enter slow fix mode 116 switches back to a slow fix mode from a fast fix mode after it attempts to get 4 additional fast fixes (regardless as to whether fast fixes are successful or not). In accordance with the principles of the present invention, rather than evaluating 3 individual geofence side conditions based on 3 individual sample location points retrieved for a target device, the inventive enter slow fix mode 116 evaluates a single geofence side condition (i.e. trigger side) using a least squares location estimate based on 5 collective sample location points retrieved for a target device.

Get location 118 is yet another step modified in the present invention. Modifications implemented within the least squares geofence method enable step get location 118 to acquire a larger number of medium quality data points (i.e. sample location points) for a target device in a shorter period of time. In accordance with the principles of the present invention, a larger number of data points (i.e. sample location points) of medium quality are more valuable to the least squares geofence method, than a small number of data points of better quality.

Table 4 depicts locate timeouts performed via an existing get location step.

TABLE 4

| Fix Mode | Occurrence | Fix Type | Timeouts |
|---|---|---|---|
| Slow Fix | At most every 10 | Optimal | 45 s GPS, 45 s |
| | minutes | Fix | Network |
| Slow Fix | At most every 3 | GPS Fix | 45 s GPS |
| | minutes | | |
| Fast Fix | At least 2 additional | Optimal | 45 s GPS, 45 s |
| | locates, at most 4 | Fix | Network |
| | additional locates | | |

In particular, Table 4 depicts fix occurrence, fix types, and locate timeouts implemented by an existing get location step 118, for individual fix modes implemented in the existing geofence method.

In accordance with the principles of the present invention, conventional 3 data point samples do not adequately represent the full variability of location data retrieved for a target wireless device. Rather, 3 data point samples result in data with high variability and consequently yield numerous geofence misfires when used to compute location estimates in the inventive least squares (LS) geofence method.

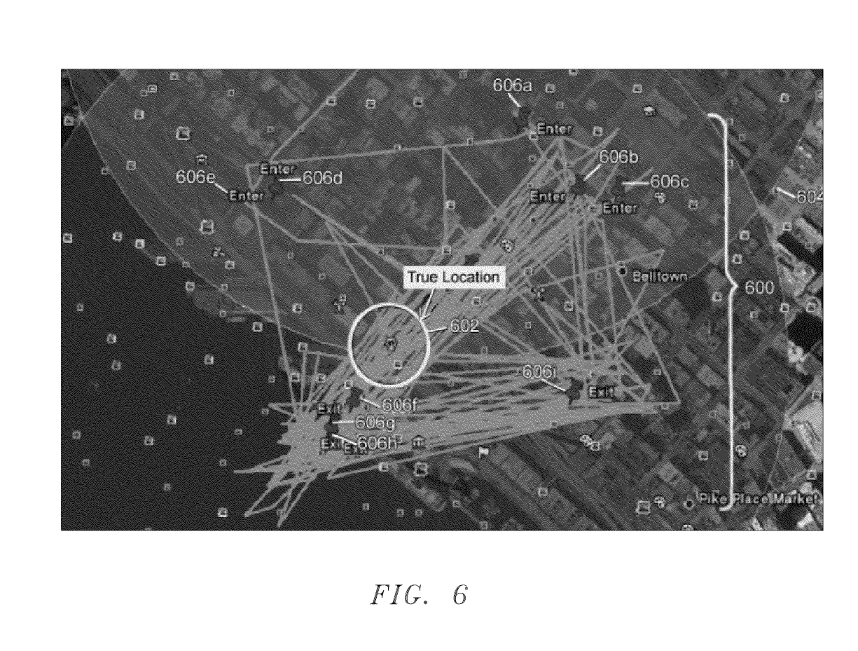

FIG. 6 depicts exemplary trigger misfires generated when location estimates are computed using 3 data point samples retrieved for a target wireless device, in accordance with the principles of the present invention.

In particular, FIG. 6 portrays location information 600 for a target device 602 that passes through a northern geofence and afterwards remains on the boundary of that northern geofence, located well within a southern geofence. FIG. 6 additionally depicts least squares (LS) location estimates 604 computed using 3 data point samples retrieved for that target wireless device 602. As depicted in FIG. 6 location estimates computed using 3 data point samples inaccurately depict the device 602 jumping in and out of the northern geofence, hence provoking numerous trigger misfires 606.

Least squares (LS) location estimates computed using a series of sample location points retrieved for a target wireless device are more accurate than least squares (LS) location estimates computed using 3 data point samples.

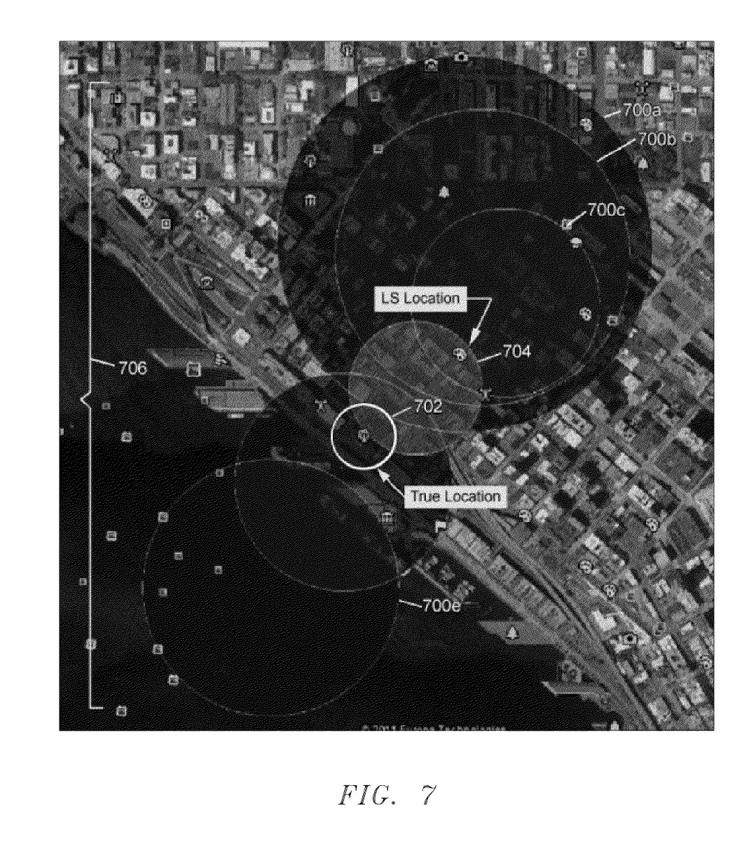

FIG. 7 depicts error circles for a series of indoor locates retrieved for a target wireless device, in accordance with the principles of the present invention.

In particular, error circles 700 depicted in FIG. 7 indicate that even when accuracies for individual locations 700 are poor, a least squares (LS) location estimate 704 computed using a series of locations 706 may provide a good indication of a device's true location 702.

The number of trigger misfires generated by the least squares geofence method significantly decreases when least squares location estimates are computed using 5 sample location points.

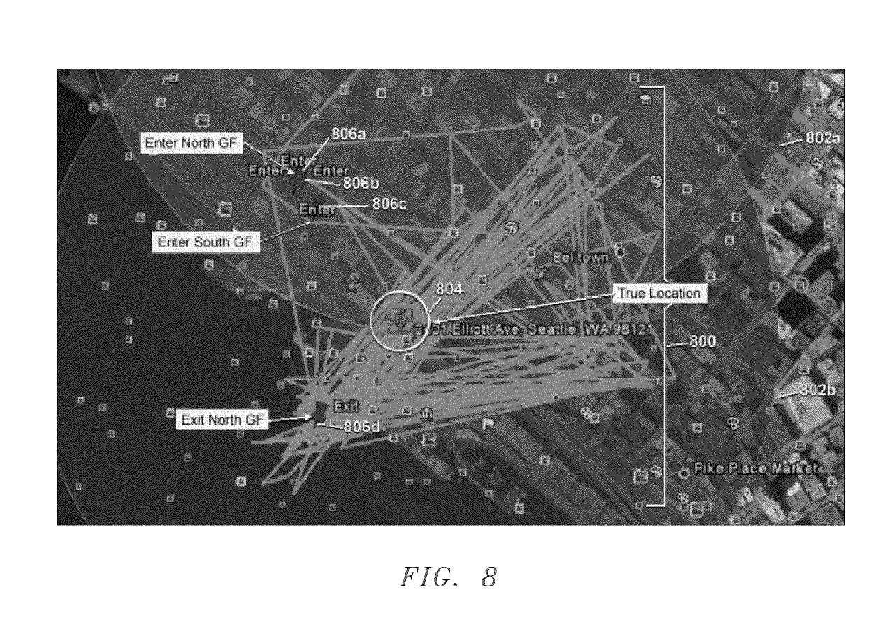

FIG. 8 depicts exemplary geofence triggers generated when a location estimate is computed using 5 sample location points retrieved for a target wireless device, in accordance with the principles of the present invention.

In particular, FIG. 8 depicts location information 800 and least squares (LS) location estimates 802 computed using 5 sample location points (i.e. 5 sample location points) retrieved for a target wireless device 804. A comparison of FIG. 8 to FIG. 6 (i.e., FIG. 6 portrays location estimates computed using 3 sample location points) shows that fewer trigger misfires 806 are generated when location estimates 802 are computed using a 5 data point sample as opposed to a 3 data point sample.

However, retrieving 5 sample location points using the existing get location 118 step results in a maximum delay of 7.5 minutes under indoor conditions. Consequently, the least squares geofence method modifies the existing get location 118 step to use a 15 second GPS locate timeout during a fast fix cycle as opposed to a conventional 45 second GPS locate timeout. Modifications to the existing get location 118 step enable a larger number of medium quality data points (i.e. sample location points) to be acquired in a shorter period of time.

Table 5 depicts locate timeouts performed via a modified get location 118 step, in accordance with the principles of the present invention.

TABLE 5

| Fix Mode | Occurrence | Fix Type | Timeouts |
|---|---|---|---|
| Slow Fix | At most every 3 | Optimal | 45 s GPS, 45 s |
| | minutes | Fix | Network |
| Fast Fix | 4 additional locates | Optimal | 15 s GPS, 45 s |
| | | Fix | Network |

In particular, Table 5 depicts GPS locate timeouts and corresponding fix types used with different fix modes in the get location 118 step modified within the present invention. In addition, Table 5 articulates time allotted between individual location fixes for individual fix modes implemented within the inventive least squares geofence method.

To compare inventive and existing geofence performance, the least squares geofence method was implemented on Android™ devices using FLHybrid without a combo location provider. SCG preload build 62 was used as a baseline for the existing geofence method. FLHybrid and SCG were both loaded on the same devices with identical geofences set up on both platforms to guarantee identical testing conditions.

The least squares geofence method was additionally implemented on Research in Motion (RIM™) devices using FLA and compared with the existing geofence method. Simultaneous testing was performed using two separate devices carried by the same tester. However, comparative testing implemented on RIM™ devices was performed using different phone models, thereby affecting the availability and quality of location data.

In accordance with the principles of the present invention, the least squares geofence method generates entry/exit geofence triggers within a reasonable amount of time and distance for devices located in urban or indoor environments.

For example, an Android™ device was placed outside a geofence, turned OFF and subsequently turned back ON inside the geofence at an indoor location with no GPS access. Once the device was turned back on (inside the geofence), the least squares geofence method initiated a fast fix cycle immediately after acquiring a first indoor locate. After 5 successful indoor locates, the least squares geofence method computed a least squares (LS) location estimate for the Android™ device and generated an appropriate entry event.

After ensuring that the least squares geofence method was provided enough time to acquire several successful indoor locates, the Android™ device was turned OFF and subsequently turned back ON outside the geofence, at an indoor location with no GPS access. The least squares geofence method then initiated a fast fix cycle immediately after acquiring a first indoor locate. After 5 successful indoor locates, the least squares geofence method computed a least squares (LS) location estimate for the Android™ device and generated an appropriate exit event.

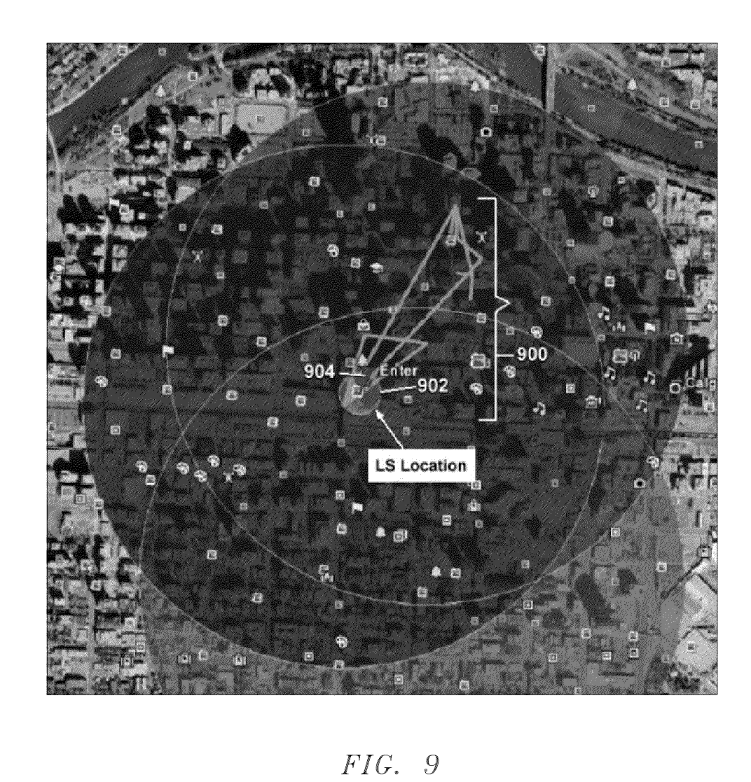

FIG. 9 depicts an exemplary entry event triggered by the least squares geofence method based on indoor locates retrieved for a target wireless device, in accordance with the principles of the present invention.

In particular, FIG. 9 depicts location information 900 for a device that was placed outside a geofence, turned OFF and subsequently turned back ON inside the geofence at an indoor location with no GPS access. Moreover, FIG. 9 depicts an appropriate entry event 904 generated by the least squares geofence method, based on a least squares (LS) location estimate 902 computed using 5 successful indoor locates retrieved for the target wireless device.

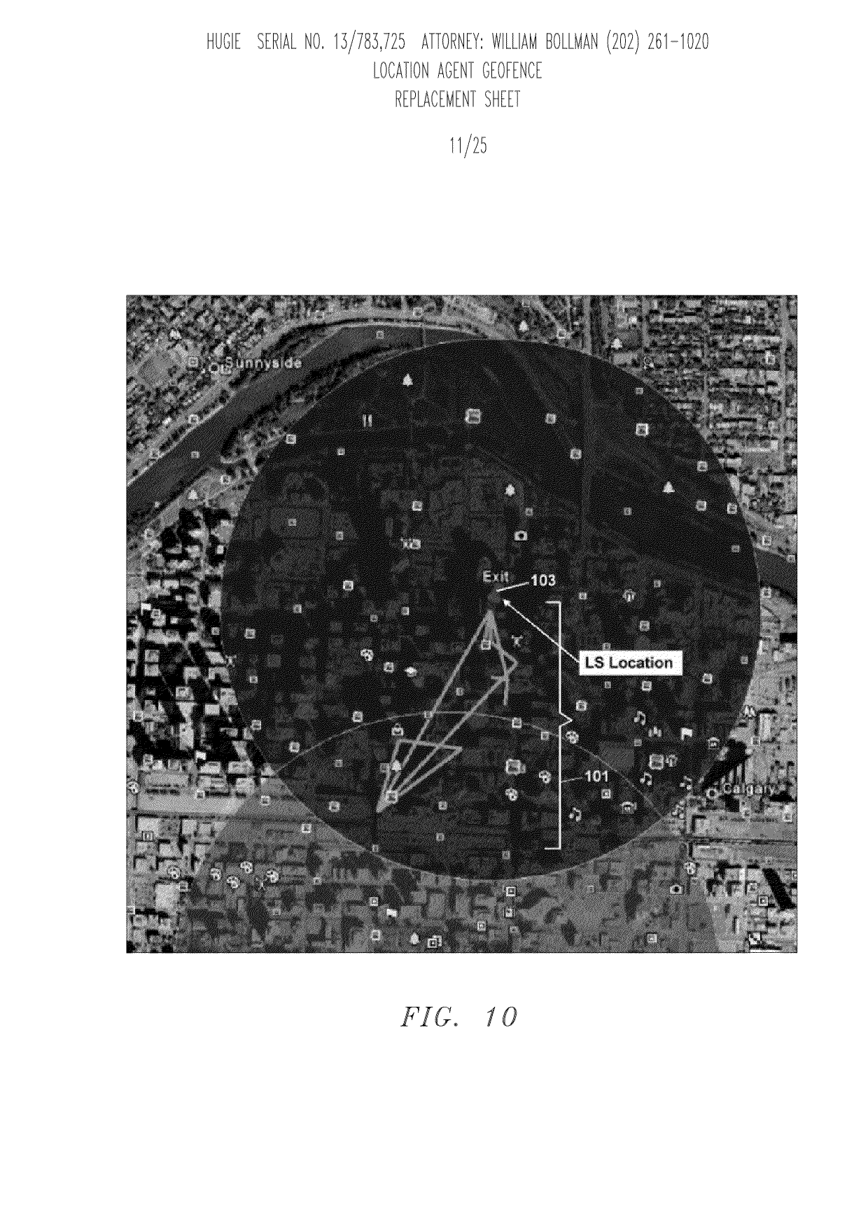

FIG. 10 depicts an exemplary exit event triggered by the least squares geofence method based on indoor locates retrieved for a target wireless device, in accordance with the principles of the present invention.

In particular, FIG. 10 depicts location information 101 for a device that was turned OFF inside a geofence and subsequently turned back ON outside a geofence at an indoor location with no GPS access. Furthermore, FIG. 10 additionally depicts an appropriate exit event 103 generated by the least squares geofence method following 5 successful indoor locates retrieved for the target wireless device.

However, unlike the least squares geofence method, the existing geofence method was not able to trigger an entry event nor an exit event for indoor locates depicted in FIGS. 9 and 10.

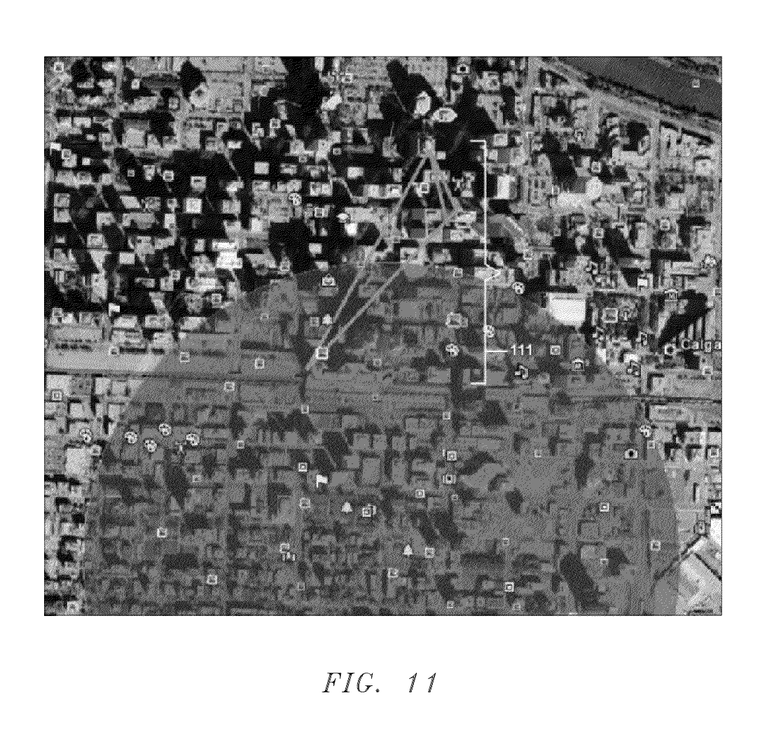

FIG. 11 depicts exemplary trigger misfires experienced by the existing geofence method for a target device located in an indoor environment.

In particular, FIG. 11 depicts location information 111 for a target device that was placed outside a geofence, turned OFF, and subsequently turned back ON inside the geofence, at an indoor location with no GPS access. However, as depicted in FIG. 11, the existing geofence method was not able to trigger an entry event nor an exit event based on location information retrieved for the target wireless device.

In accordance with the principles of the present invention, the least squares geofence method does not generate trigger misfires for devices that straddle a geofence boundary for an extended period of time.

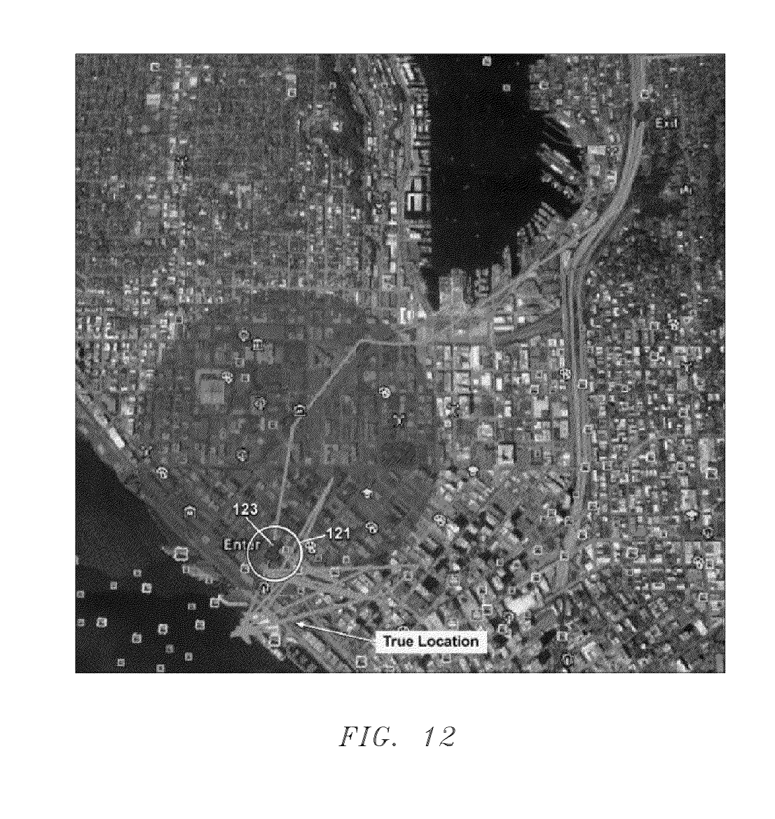

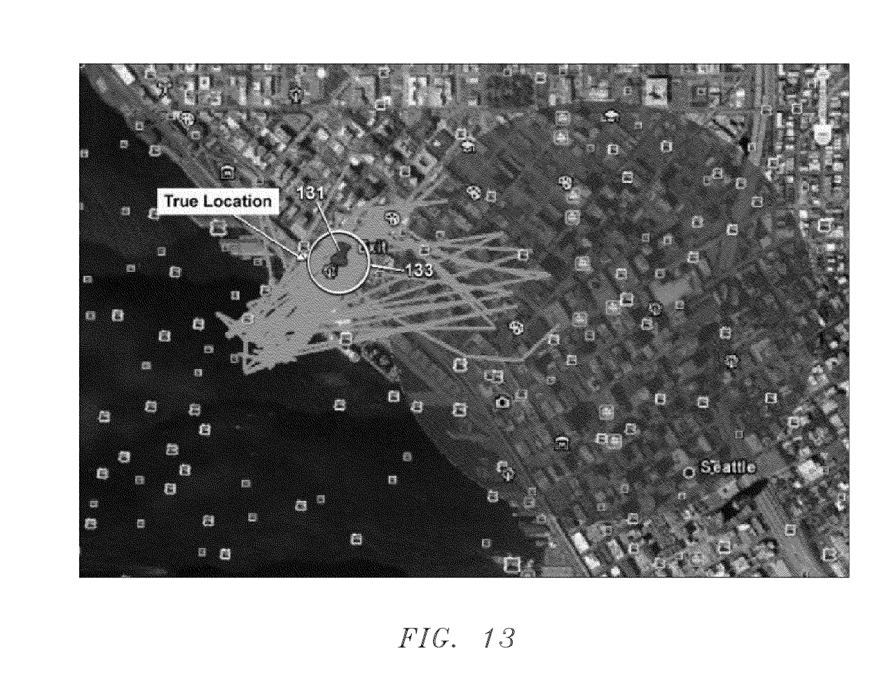

FIG. 12 portrays an entry trigger generated for a device straddling a geofence boundary for a prolonged period of time, in accordance with the principles of the present invention.

As depicted in FIG. 12, a target device resides on a boundary of a geofence (i.e. outside a geofence) 121, with several locations for that particular target device reported inside the geofence. However, no entry triggers are generated by the least squares geofence method until the device physically enters the geofence and passes through it. Hence, an entry event 123 is only triggered for the target wireless device when the least squares geofence method has sufficient confidence that the device has indeed entered the geofence. As depicted in FIG. 12, the least squares geofence method is able to capture true variability in data retrieved for a target wireless device.

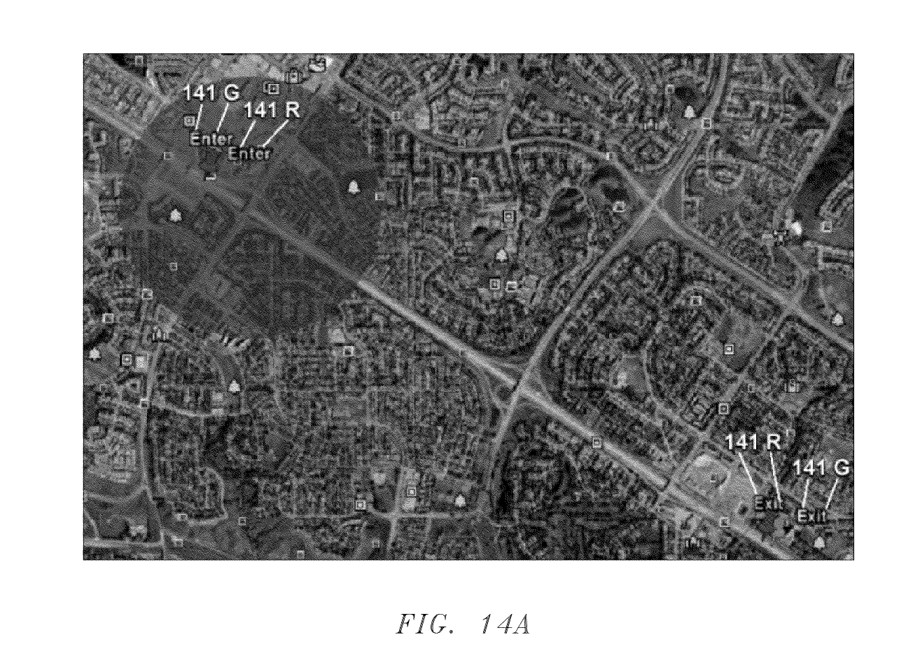

FIG. 13 portrays an exit trigger generated for a device straddling a geofence boundary for a prolonged period of time, in accordance with the principles of the present invention.

As shown in FIG. 13, a target device exits a geofence then resides near the boundary 133 of that geofence, with several locations for that particular target device reported inside the geofence. As depicted in FIG. 13, the least squares geofence method generates an exit trigger 131 for the target device immediately after the device exits the geofence. No subsequent re-entries are triggered.

In accordance with the principles of the present invention, the least squares geofence method performs on par with the existing geofence method in outdoor, high GPS environments.

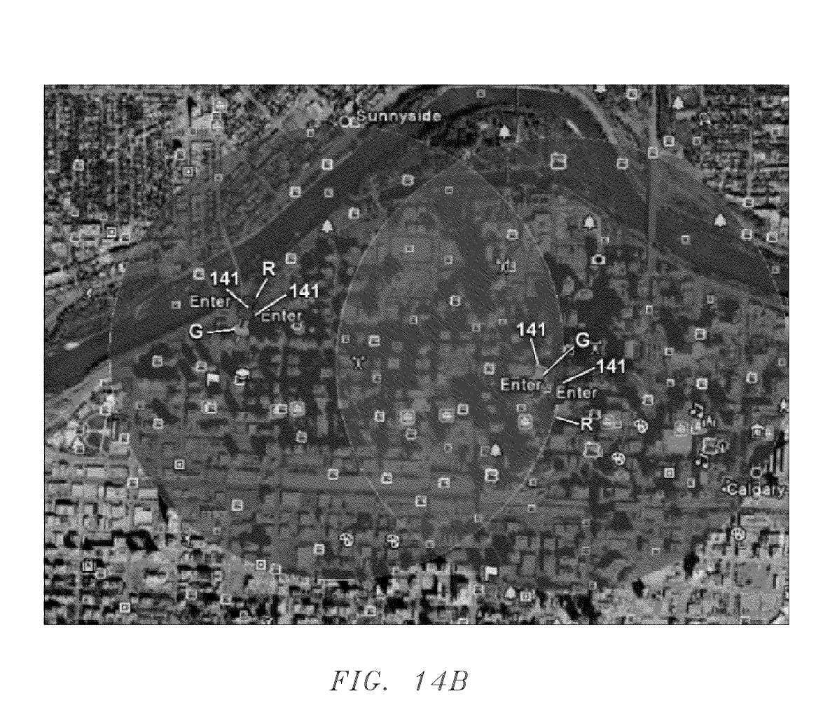

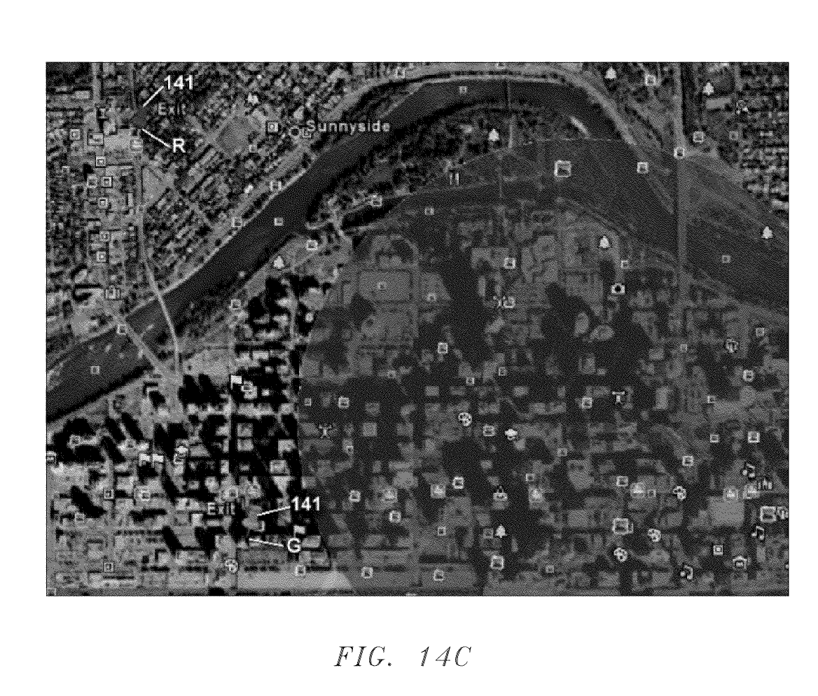

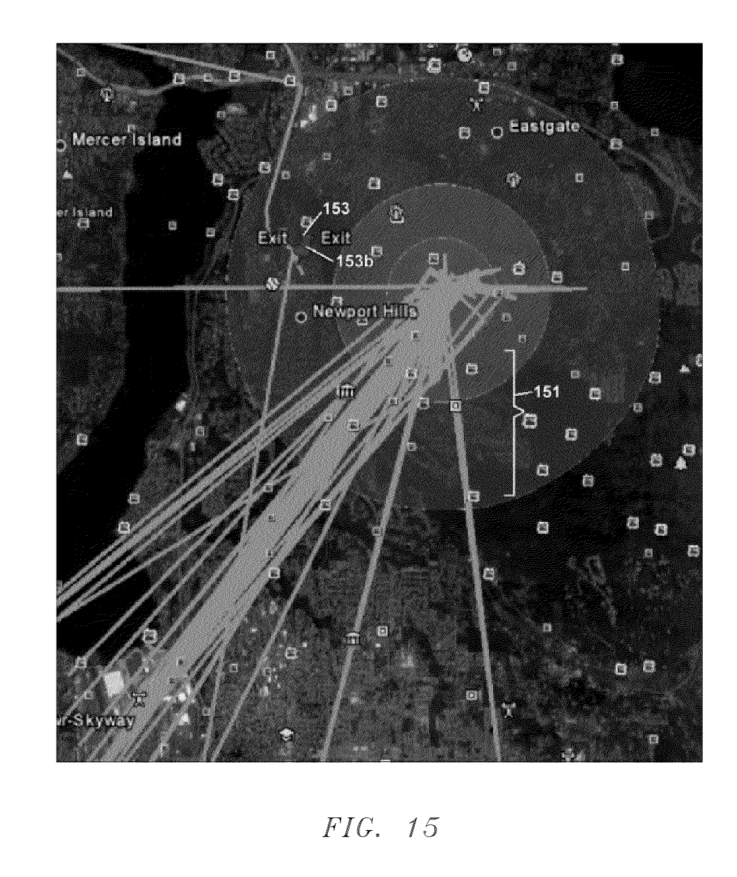

FIGS. 14A through 14C depict exemplary geofence events triggered by the least squares geofence method and the existing geofence method based on outdoor locates retrieved for a target wireless device, in accordance with the principles of the present invention.

In particular, pins labeled ‘G’ in FIGS. 14A through 14C indicate location of events 141 triggered by the least squares geofence method. Pins labeled ‘R’ in FIGS. 14A through 14C, indicate location of events 141 triggered by the existing geofence method. As depicted in FIGS. 14A through 14C, appropriate geofence events 141 are triggered by both the least squares geofence method and the existing geofence method for devices located in outdoor, high GPS environments. However, the least squares geofence method is able to issue exit events earlier than the conventional geofence method for devices located in urban environments.

FIG. 14C depicts exit events 141 generated by the least squares geofence method and the existing geofence method for a target wireless device located in an urban environment. As portrayed in FIG. 14C, the least squares geofence method triggers an exit event 141G for the target wireless device two minutes earlier than the conventional geofence method triggers the same exit event 141R.

In accordance with another aspect of the present invention, the least squares geofence method avoids various blunders that are otherwise unavoidable in the existing geofence method. For instance, the existing geofence method occasionally triggers exit events for devices that are stationary within a geofence, whereas the least squares geofence method does not.

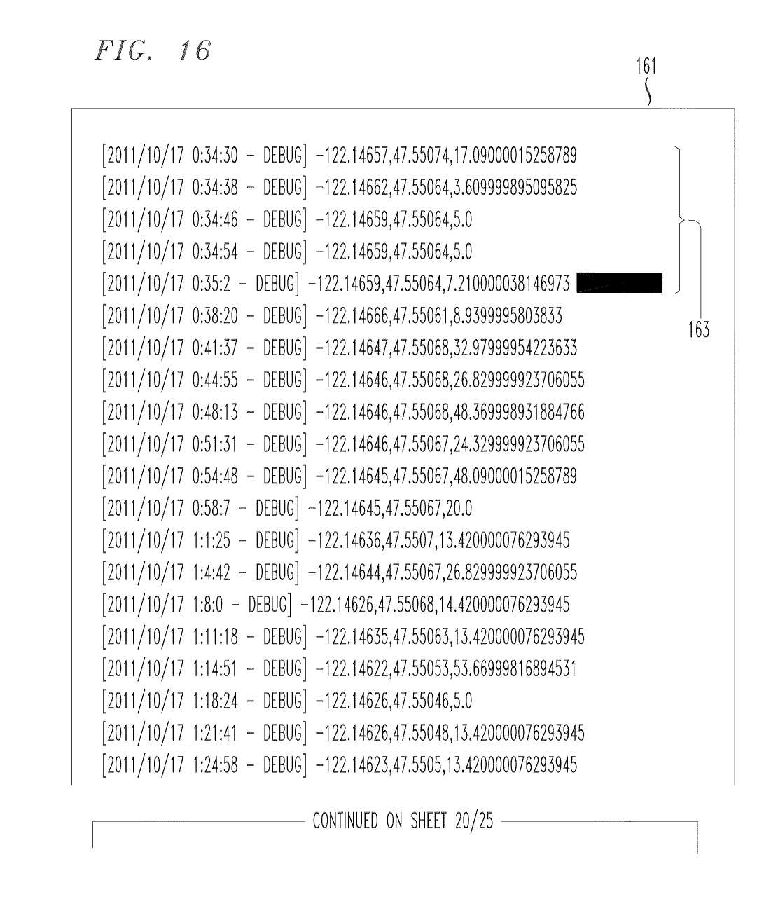

FIG. 15 shows location information for a wireless device that is resident within three defined geofences, in accordance with the principles of the present invention.

In particular, FIG. 15 depicts severe location blunders 151 incurred for a device located within three defined geofences. However, despite location blunders, the least squares geofence method does not experience any trigger misfires. Rather, the least squares geofence method triggers two valid exit events 153 once the device exits the inner two geofences, as depicted in FIG. 15.

In accordance with the principles of the present invention, the least squares geofence method does not obtain significantly more locates than the existing geofence method.

For example, the least squares geofence method retrieves sample location points approximately every 3 minutes for a stationary Research In Motion (RIM™) device placed inside a geofence overnight. This 3 minute interval is the same interval the existing geofence method uses to retrieve sample location points for a target wireless device.

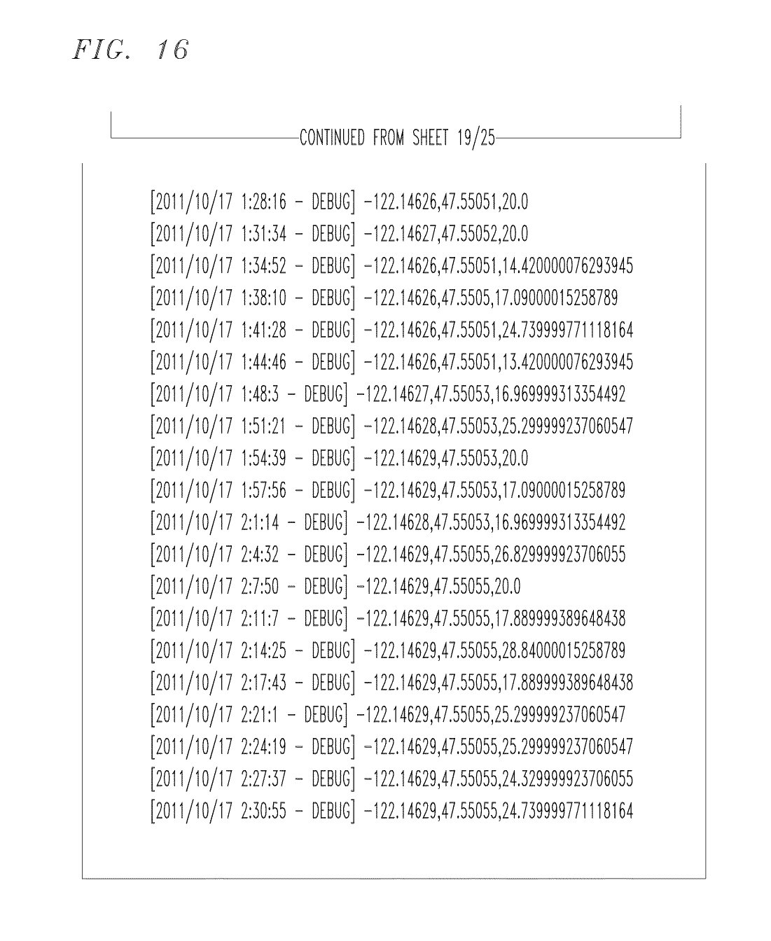

FIG. 16 portrays a locations log for an exemplary device that is stationary inside a geofence, in accordance with the principles of the present invention.

In particular, FIG. 16 shows an exemplary locations log 161 of location updates requested by the least squares geofence method for a wireless device that enters a geofence at approximately 0:34 GMT. FIG. 16 additionally depicts five sample location points 163 used to trigger an entry event for that particular wireless device.

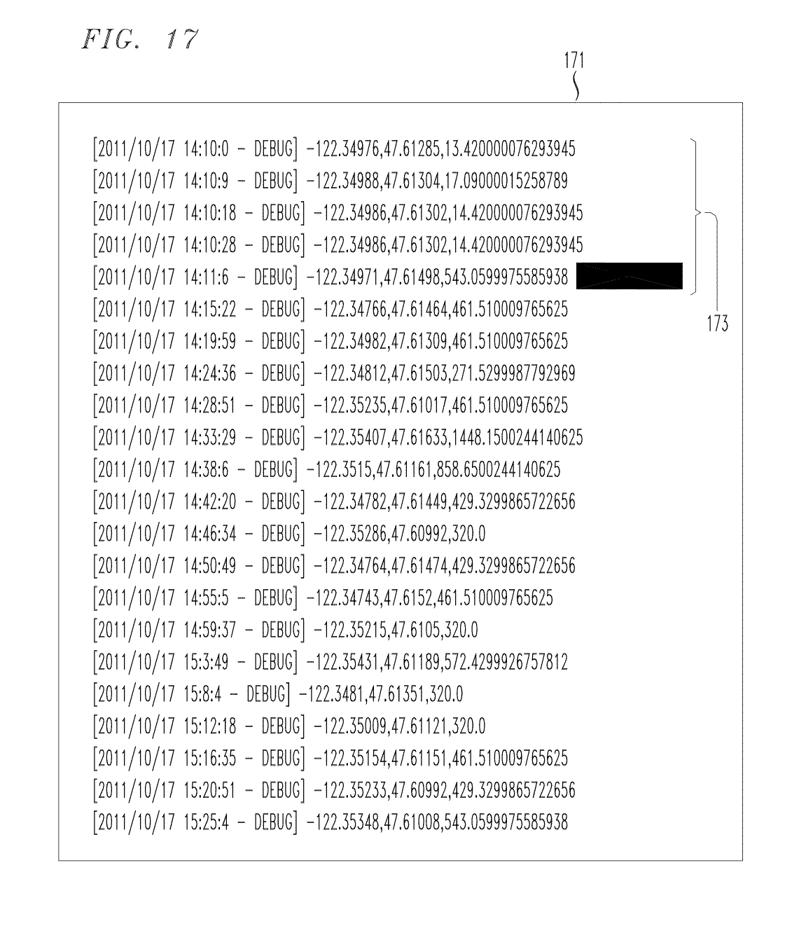

FIG. 17 portrays an exemplary locations log for a wireless device that exits a geofence and remains near the boundary of that geofence, in accordance with the principles of the present invention.

In particular, FIG. 17 depicts a locations log 171 of location updates requested by the least squares geofence method for a device that exits a geofence and then remains near the boundary of that geofence. As depicted in FIG. 17, even under boundary conditions, location updates are only requested by the least squares geofence method approximately every 3 minutes. FIG. 17 also depicts five sample location points 173 used to generate an exit event for the corresponding wireless device.

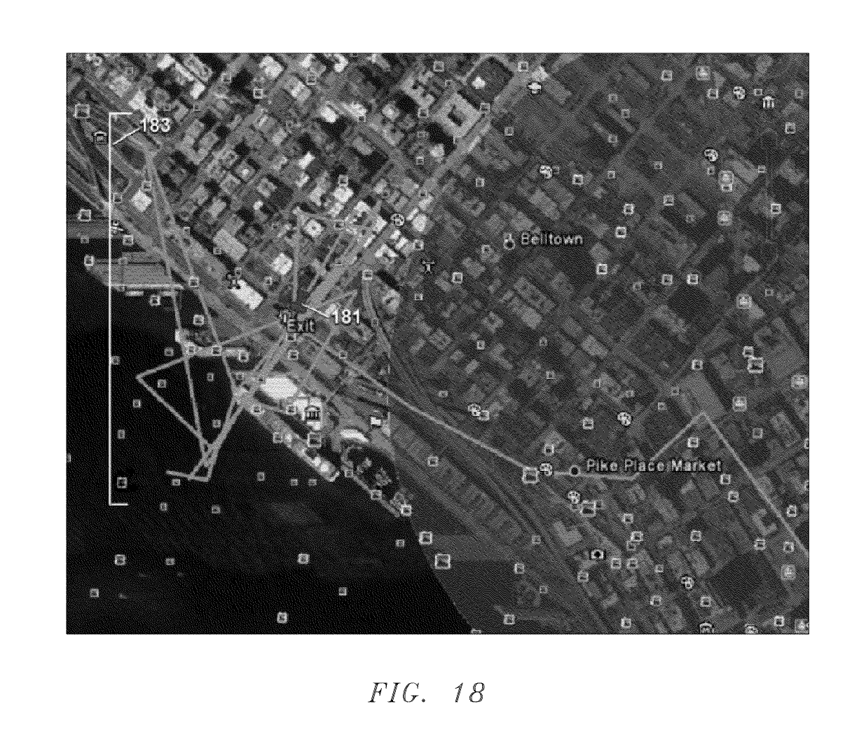

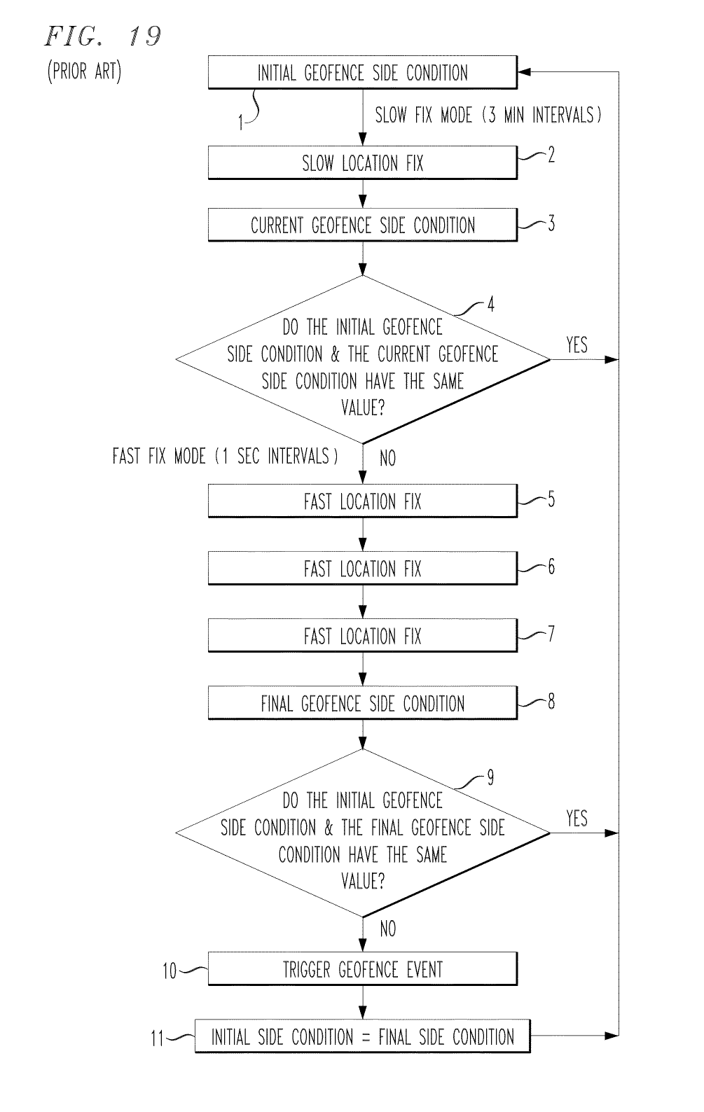

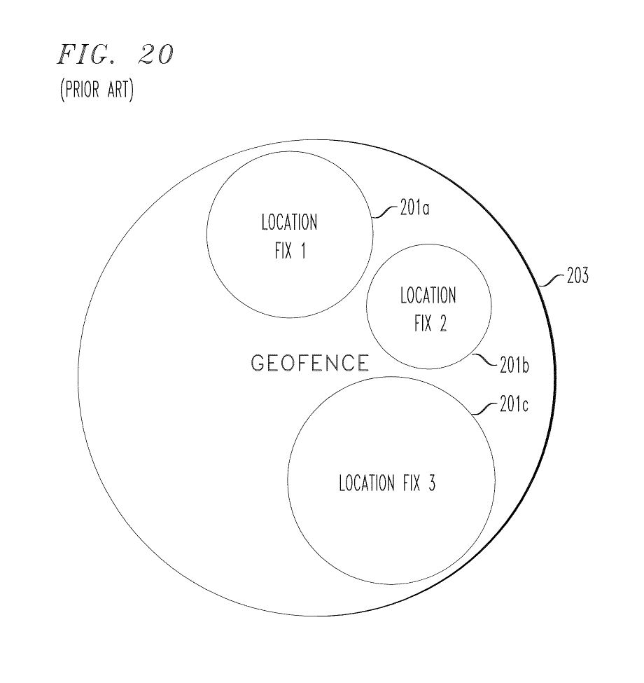

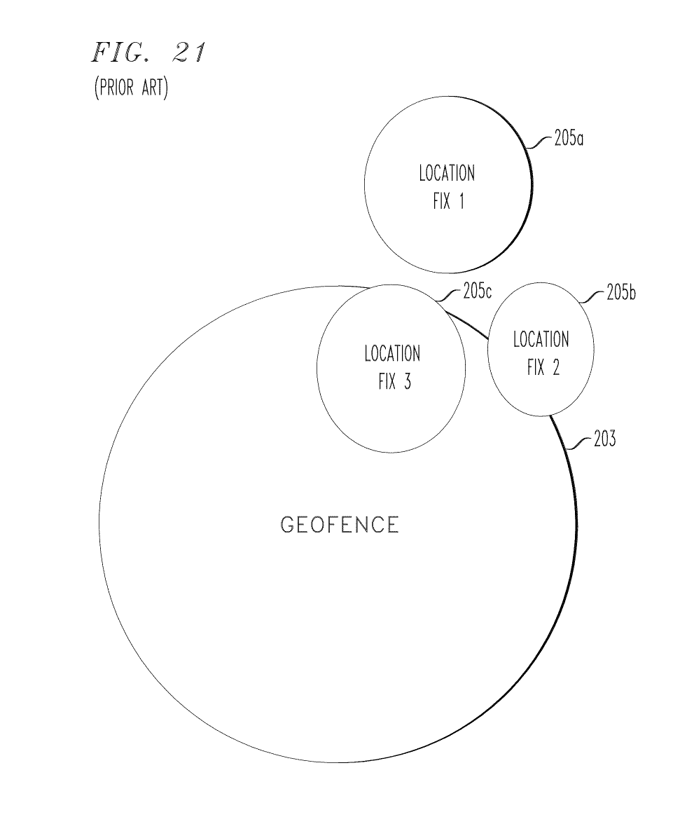

FIG. 18 shows a map of locations relative to the location log depicted in FIG. 17.

In particular, FIG. 18 depicts an exit trigger 181 generated for a target wireless device, based on sample location points 173 retrieved for that device and logged in the locations log depicted in FIG. 17. FIG. 18 also depicts subsequent location information 183 retrieved for the relevant target device, relative to location updates indicated in the locations log 171 depicted in FIG. 17.

In accordance with the principles of the present invention, the least squares geofence method increases sensitivity under indoor conditions where GPS is not available, and extracts meaningful information even from poor quality sample location points. In addition, the least squares geofence method is able to obtain a statistical location estimate for a target wireless device based on multiple sample location points, thereby increasing the probability of valid “entry” events under urban or indoor conditions. The existing geofence method, however, is extremely sensitive to position quality under indoor conditions and unable to obtain network locates in many circumstances.

The least squares geofence method is additionally capable of extracting more information from input data than the existing geofence method, thereby rendering location blunders less detrimental to the least squares geofence method. In addition, the present invention only filters extreme blunders, so the model's degree of fit determines whether or not additional blunders are present. Furthermore, the least squares geofence method is able to reduce exit misfires caused by blunders such as cell tower hopping while still allowing the least squares (LS) model to use all location information with accuracies less than 1 km.

Geofence sensitivity is increased in the least squares geofence method, hence extreme data variability (>1 km) becomes a problem when variability straddles a geofence border for a prolonged period of time. As portrayed in FIG. 8, a majority of data variability is captured in a least squares (LS) location estimate computed using 5 sample location points. However, if there are 5 consecutive highly correlated data points far enough inside or outside a predefined geofence, an entry/exit event may be triggered. Although decreasing the sensitivity of the geofence would reduce trigger misfires, decreased sensitivity would also reduce the effectiveness of the geofence. Fortunately, prolonged variability greater than 1 km is not common, and administrators typically center geofences around resting locations.

In accordance with the principles of the present invention, modifications to the GPS fix timeout implemented in fast fix mode does not significantly affect the geofence in the least squares geofence method, because the GPS chip is hot after the first optimal fix in slow fix mode is implemented. Furthermore, GPS fixes are preferably readily available in rural environments. However, should a GPS fix be unavailable, the least squares geofence method may become susceptible to network location biases due to weak cell tower geometry and sparse cell towers in rural environments.

The least squares geofence method has sufficient sensitivity to support quarter mile geofences. Under severe data variation conditions, boundary effects may be significant for guarter mile geofences because 1 km location variations become significant for a quarter mile (805 m) diameter geofence.

The least squares geofence method does not adversely affect battery consumption. The number and frequency of sample location points retrieved for a target wireless device are identical in the least squares geofence method and the existing geofence method under most circumstances. However, the least squares geofence method performs more fast location fixes than the conventional geofence method, thereby resulting in increased battery consumption. However, fast fixes now have a shorter GPS timeout, which reduces battery consumption under urban or indoor conditions.

While the invention has been described with reference to the exemplary embodiments thereof, those skilled in the art will be able to make various modifications to the described embodiments of the invention without departing from the true spirit and scope of the invention.

What is claimed is:

1. A least squares geofence method that supports improved geofencing, comprising:
a get trigger side fast step;
a filter locations step;
a calculate least squares location step; and
an entering or exiting filter step.

2. The least squares geofence method that supports improved geofencing according to claim 1, wherein:
said least squares geofence method uses a least squares model to compute a location estimate for a target device.

3. The least squares geofence method that supports improved geofencing according to claim 1, wherein:
said get trigger side fast step uses a point in circle algorithm to alert said least squares geofence method to a potential change in geofence side condition for a specified target device.

4. The least squares geofence method that supports improved geofencing according to claim 1, wherein:
said filter locations step filters sample location points retrieved for a target device to minimize the effect of coarse locates on location estimates computed for said target device.

5. The least squares geofence method that supports improved geofencing according to claim 4, wherein said filter locations step filters said sample location points retrieved for said target device:
with accuracies greater than 1 km.

6. The least squares geofence method that supports improved geofencing according to claim 1, wherein:
said calculate least squares location step uses a weighted least squares model to compute a least squares fit of sample location points retrieved for a target device.

7. The least squares geofence method that supports improved geofencing according to claim 1, wherein:
said entering or exiting filter step filters a least squares location estimate computed for a target device.

8. The least squares geofence method that supports improved geofencing according to claim 7, wherein said entering or exiting filter step:
uses a 500 m loose exiting filter to filter a least squares location estimate computed for a device potentially exiting a geofence.

9. The least squares geofence method that supports improved geofencing according to claim 7, wherein:
said entering or exiting filter uses a 100 m tighter exiting filter to filter a least squares location estimate computed for a device potentially entering a geofence.

10. A least squares geofence method that supports improved geofencing according to claim 1, wherein:
existing geofence step wait until next fix time is modified to only take location position in to account.

11. A least squares geofence method that supports improved geofencing according to claim 1, wherein:
existing step enter slow fix time is modified to switch back to a fast fix mode from a slow fix mode after attempting to get 4 additional fast fixes for a target wireless device.

12. A least squares geofence method that supports improved geofencing according to claim 1, wherein:
existing step get location is modified to use a 15 second GPS timeout in a fast fix cycle.

13. A method of implementing a least squares geofence method, comprising:
determining a time and technique to gather sample location points for a target wireless device;
determining a location estimate for said target wireless device based on said gathered sample location points;
filtering said determined location estimate based on a current state of said target wireless device; and
determining if an event has been triggered.
